(19) United States
(12) Patent Application Publication
(10) Pub. No.: US 2011/0022949 A1
(43) Pub. Date: Jan. 27, 2011

(54) CONTROL OF CONCENTRATION OF FEED ITEMS IN AN AGGREGATED FEED DOCUMENT

(76) Inventors: Hugo Hallman, Djursholm (SE); Jan Markborg, Jarfalla (SE)

Correspondence Address: MYERS BIGEL SIBLEY & SAJOVEC, PO BOX 37428, RALEIGH, NC, 27627, US

(21) Appl. No.: 12/935,678

(22) PCT Filed: Apr. 30, 2008
(86) PCT No.: PCT/SE08/50497

§ 371 Date: Sep. 30, 2010

(51) Int. Cl. G06F 17/20

(52) U.S. Cl. 715/255

(57) ABSTRACT

The invention relates to a method and arrangement for inserting feed items from different feed documents into an aggregated feed document. A feed aggregator receives feed items, each comprising a feed item ID, from feed documents and inserts them into an aggregated feed document. The feed aggregator decides if a second feed item from a second feed document shall be inserted to the aggregated feed document by using the a first feed item ID of a first feed item from a first feed document. The feed aggregator calculates a first feed item ID value of the first feed item ID associated with the first feed item and use said first feed item ID value to decide if a second feed item from the second feed document shall be inserted into the aggregated feed document. If that will be the case, the feed aggregator changes a second feed item ID associated with the second feed item to a changed feed item ID related to characteristics of the first feed item ID that gave the result of inserting the second feed item to the aggregated feed document. The feed aggregator then inserts the second feed item from the second feed document with the changed feed item ID to the aggregated feed document. One advantage of the invention is that the concentration of feed items from specific feed channels can be controlled.

### TECHNICAL FIELD

The invention relates to aggregation of feed documents.

### BACKGROUND

It is today possible to get information concerning updates of web pages, diaries, news and user status delivered to an end-user. This information can be presented in a feed document comprising a list of feed items. The feed items comprise text or other content.

News is a well know example of using feed documents but it could of course be any information from any feed channel. Feed documents could be presented on a PC but also on mobile phones or other terminals.

RSS 2.0 (Really Simple Syndication), is a web content syndication format. An RSS channel, is presented as a XML file. Required elements for an RSS 2.0 channel are: the title of the RSS channel, a link in the form of URL (Uniform Resource Locator) to the web page of the RSS channel and a description of the RSS channel. The RSS channel may comprise several items, RSS items, which comprises contents, e.g. title of the item, link to the item and description of the item. The items could also have globally unique identifiers (guid). Examples of other standards in this area are RSS 0.9, RSS 2.0 and ATOM.

The content of an RSS item can be read using an RSS reader on e.g. a mobile phone. The user subscribes to a feed document by entering the feed's link into the reader or by clicking an RSS icon in a browser that initiates the subscription process. The user then decides how often the subscribed feed document is to be automatically updated and sent to the device.

It is possible to aggregate different feed documents into an aggregated feed document by using a feed aggregator. All news, independent of the feed channel, could then be presented in an aggregated feed document. This is of course convenient for the user.

In case of an aggregated feed document, it could be useful to control the concentration of items from a specific feed document. An operator may e.g. give the user a better price on his mobile subscription if he accepts a certain percentage of advertisement in his aggregated feed document.

It is then useful to control the concentration of feed items coming from the advertisement channel. There could of course also be other reasons why the concentration of feed items from a certain feed channel would be interesting to control. The invention has a solution to this problem.

### SUMMARY

The invention relates to a method and arrangement for inserting feed items from different feed documents into an aggregated feed document. A feed aggregator receives feed items, each comprising a feed item ID, from feed documents and inserts them into an aggregated feed document.

The feed aggregator decides if a second feed item from a second feed document shall be inserted to the aggregated feed document by using the a first feed item ID of a first feed item from a first feed document. The feed aggregator calculates a first feed item ID value of the first feed item ID associated with the first feed item and use said first feed item ID value to decide if a second feed item from the second feed document shall be inserted into the aggregated feed document. If that will be the case, the feed aggregator changes a second feed item ID associated with the second feed item to a changed feed item ID related to characteristics of the first feed item ID that gave the result of inserting the second feed item to the aggregated feed document. The feed aggregator then inserts the second feed item from the second feed document with the changed feed item ID to the aggregated feed document.

The rate of feed items from the second feed document is then decided by the feed aggregator. This rate will also remain in a user equipment where the unread feed item will be put at the top of the list of readable feed items.

### BRIEF DESCRIPTION OF THE DRAWINGS

FIG. 1 is a block diagram illustrating a built up aggregated feed document.

FIG. 2 is a block diagram to illustrate a system of feed channels, a feed aggregator and user equipment.

FIG. 3 is a block diagram of a first example of a built up aggregated feed document according to the invention.

FIG. 4 is a block diagram of a second example of a built up aggregated feed document according to the invention.

FIG. 5 is a block diagram illustrating user feed documents.

FIG. 6 is a block diagram illustrating the method.

FIG. 7 is a block diagram illustrating a feed aggregator according to the invention.

### DETAILED DESCRIPTION

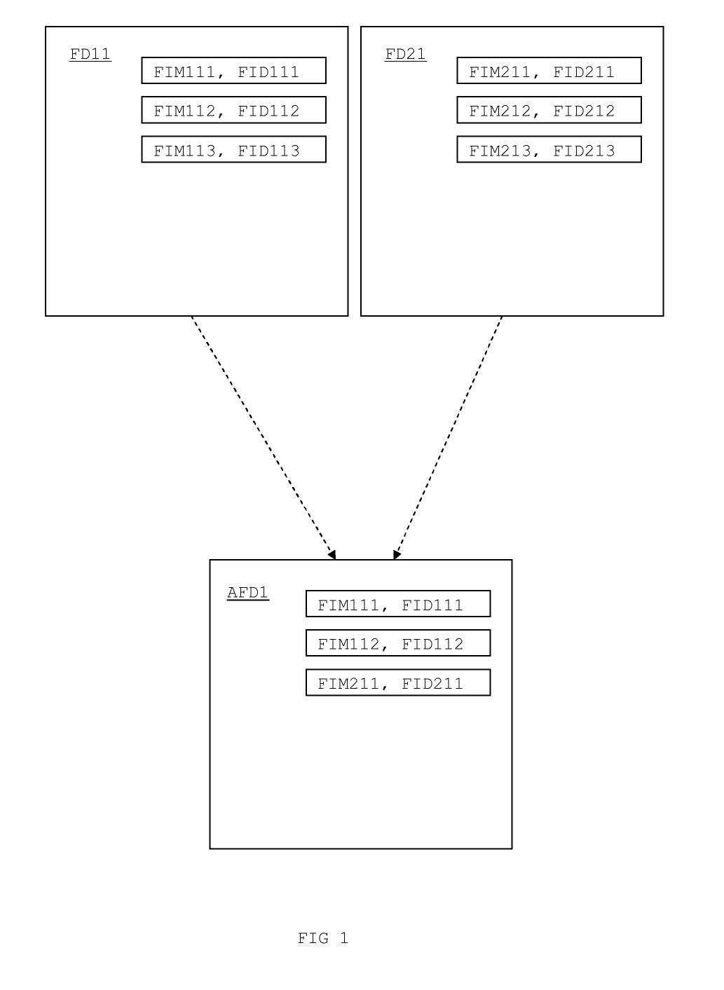

FIG. 1 illustrates two feed documents, FD11, FD21. The feed documents comprise feed items FIM111, FIM211 etc and each item has a feed item ID, FID111, FID211 etc. The feed items comprise different contents such as e.g. pictures, text, web links.

A feed aggregator can aggregate items from the two feed documents into one single document, an aggregated feed document, AFD1 in FIG. 1. There is of course no limitation to two feed documents, the aggregator may aggregate items from several feed documents from all kinds of feed channels.

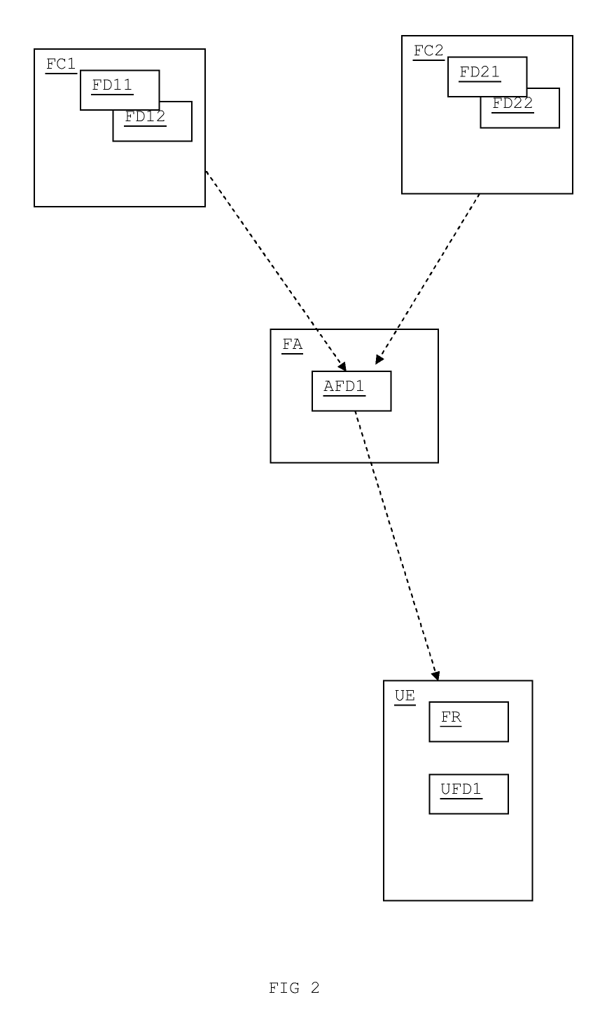

FIG. 2 illustrates a telecommunication system comprising two feed channel FC1, FC2, feed documents FD11, FD12, FD21, FD22, a feed aggregator FA, aggregated feed document AFD1, user equipment UE, feed reader FR and a user feed document UFD1.

The feed channels can update the feed document and this is illustrated by having several feed document coupled to the feed channel, FD11, FD12 etc.

The aggregated feed document AFD1 can be send to the user equipment UE. This can be done in several ways, e.g. the aggregated feed document could be pushed or pulled to the user equipment UE.

The feed aggregator FD can be situated in an application server in the operator network. The user could, e.g. via a web page, choose which feed channels it wants to receive feed documents from. Automatically or at request from the user equipment UE, an aggregated feed document could be sent to the user equipment, e.g. a mobile phone, PDA or a PC.

The user equipment comprises the feed reader FR that can present the feed items in a feed document for the reader. The feed reader can present the feed items in several ways. This presentation is in this document called the user feed document UFD1 etc. One way to present the feed items is to present them in the order they are presented in the read feed document. Another way is that the user equipment has a memory and can remember the items the user already has read and present the unread feed items first in the user feed document UFD1. The common way for the feed reader to find out which feed items is read and which one is not, is to store this information together with the feed item ID, FID111 etc.

The operator, where the user of the user equipment UE has the subscription, has the possibility to add feed items from other feed channels than the ones that the user has directly asked for. The operator has the control of the feed aggregator and could for example add feed items comprising advertisement from a chosen feed channel.

If we assume that the user should have a 10 percentage concentration of feed items from the second feed channel FC2 in FIG. 2, we could interleave every tenth item in the aggregated feed document with an item from feed document FD21. The feed aggregator can send an aggregated feed document AFD1 with a concentration of 10 percent of items from feed document FD21 to the user equipment.

However, if the feed reader in the user equipment picks out only the new or updated items from the received aggregated feed document AFD1 and put them in the user feed document UFD1, it might be another concentration than 10 percent of feed items from feed document FD21 in the user feed document. If there is only items from the second feed channel FC2 that is new since last transfer of an aggregated feed document to the user equipment, the user feed document will only be updated with items from the second feed channel FC2 and the concentration of items from the second feed channel FC2 in the user feed document will be higher than 10 percent. The invention will overcome this problem.

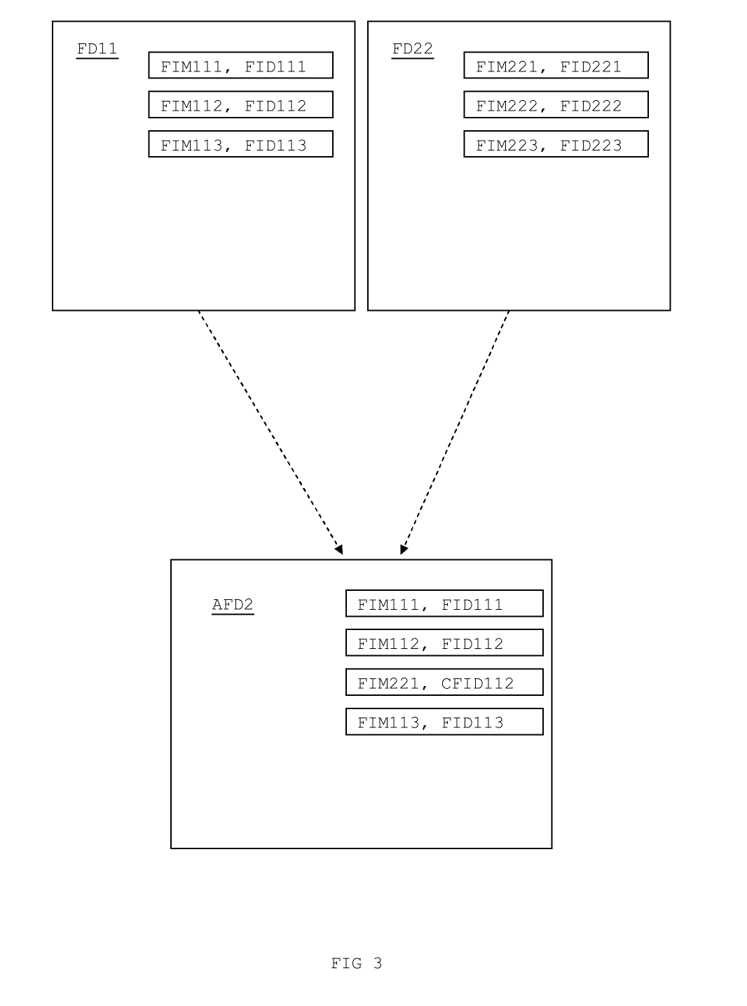

FIG. 3 illustrates an aggregated feed document AFD2 that is built up by a feed aggregator according to the invention.

In this example we have a first feed document FD11 and a second feed document FD22 from feed channel FC2 that will be aggregated into an aggregated feed document AFD2. We would like that the user, which have a feed reader FR that only presents the unread feed items, to perceive a concentration of 20% of feed items from second feed document FD22. The feed items in the second feed document FD22 could e.g. comprise advertisement that the operator wants to add to the aggregated feed document AFD2.

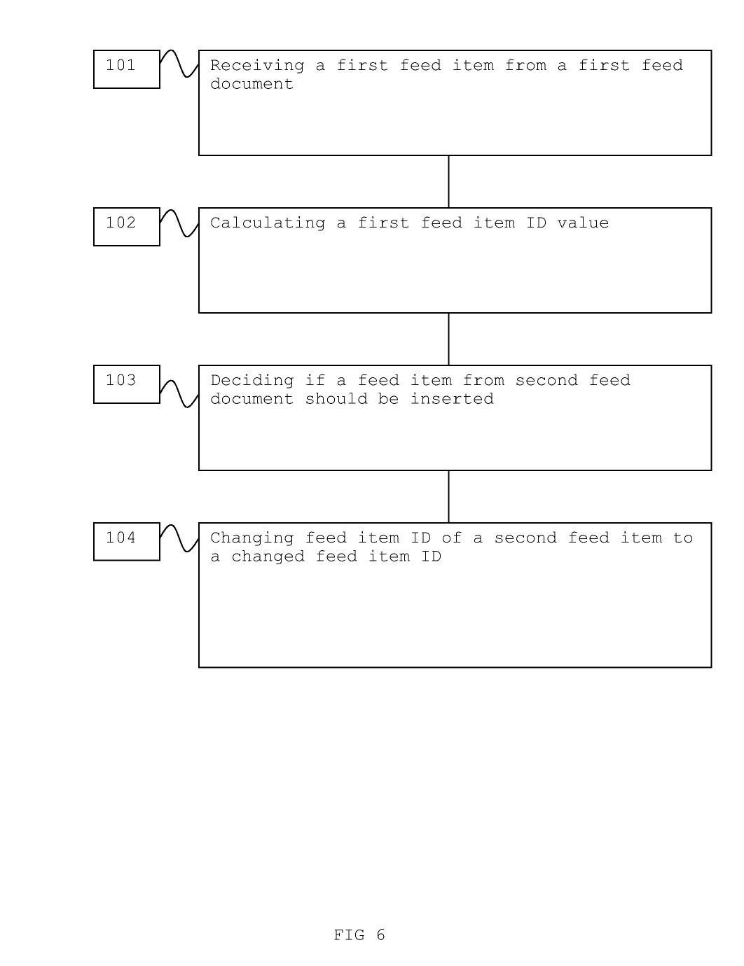

The feed aggregator will for each feed items from first feed document FD11 it add to the aggregated feed document AFD2, find out if it also should add a feed item from the second feed document FD22. The following method describes one way to build up an aggregated feed document according to the invention:
The feed aggregator receives feed items, FIM111, FIM112 etc from first feed document FD11 and add them to the aggregated feed document AFD2. A block 101 describes this step in FIG. 6.
The feed aggregator analyses chosen characteristics of the feed item ID FID111, FID112 etc. and calculates a feed item ID value FIDV111, FIDV112 etc. A block 102 describes this step in FIG. 6.
The feed aggregator uses said feed item ID value of the feed item IDs to decide if a feed item from second feed document FD22 should be added to the aggregated feed document AFD2. In this case the feed aggregator is configured so that in average 20% of the cases a feed item from the second feed document FD21 will be added to the aggregated feed document AFD2. A block 103 describes this step in FIG. 6.
When a feed item e.g. FIM221 from the second feed document FD22 is added, the feed item ID FID221 of that feed item will be changed to a changed feed item ID CFID112 related to the feed item ID FID112 of the feed item, in this example FID112, that gave the result of adding the feed item FIM221 from the second feed document to the aggregated feed list AFD2. A block 104 describes this step in FIG. 6.

The feed aggregator analyses characteristics of the feed item

ID of feed items from the first feed document to find out if a feed item from the second feed document will be added. This is done by calculating a feed item ID value FIDV111, FIDV112 etc on the feed item Id FID111, FID112 etc on the feed items from the first feed document. One example is that the feed item ID value gives a result between 0 and 9. The feed aggregator will insert a feed item from the second feed document FD22 when the feed item ID value is 0 or 1. This will give a result of 20% of feed items from the second feed document.

The feed aggregator can also decide to insert 2 or several feed items from the second feed document into the aggregated feed document every time it insert a feed item from the first feed document. It can also decide to never insert any documents from the second feed document. In this example 20% was used as an illustration. Any concentration between 0 and 100% is possible, e.g. if the feed aggregator inserts feed items from the second feed document every second time the concentration will be 50%.

The feed item ID value can be calculated by using a hash function and calculate a hash value of the feed item ID. The hash value is a random value calculated on the base of a feed item ID. The decision whether to insert a feed item from the second feed document can then be done by taking the hash value modulo 100 and compare it to the desired concentration of feed items from the second feed document. The feed item ID value could of course be calculated in any way and does not necessary have to be a number. You could have letter Y if the feed item ID has an even numbers of figures and letter N in the other cases. Y can then mean that a feed item from the second feed document shall be inserted. One specific feed item ID shall always give the same result concerning the changed feed item ID.

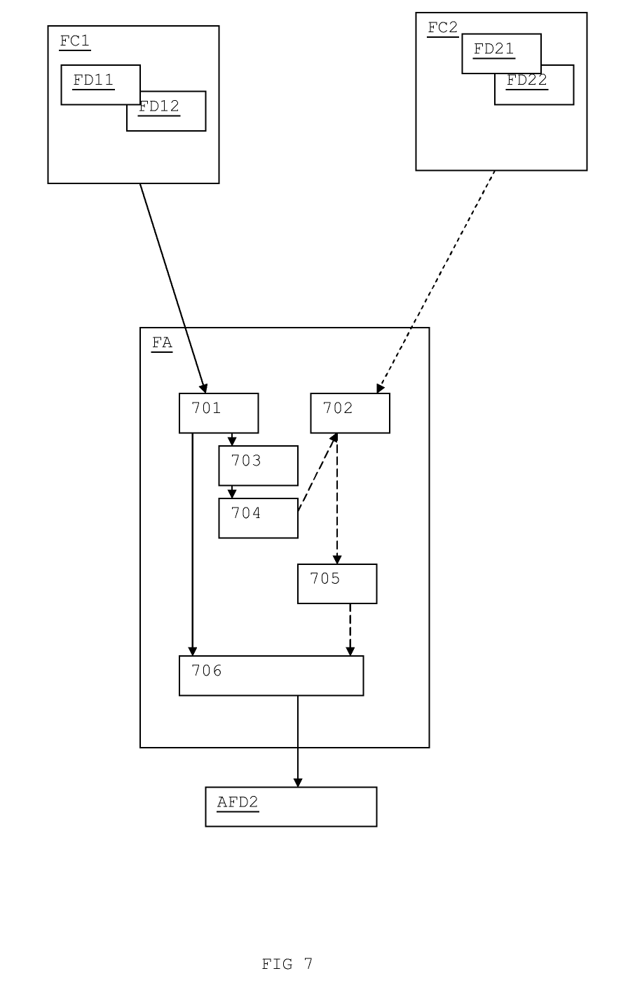

FIG. 7 illustrates the different parts of a feed aggregator FA. A feed aggregator could e.g. be implemented as a software in an application server run by a telecom operator.

The feed aggregator has means 701 and 702 for receiving feed items. The feed items can be sent to the feed aggregator every time it shall build up an aggregated feed document. Feed items are normally received in form of a feed document. The feed aggregator also has means 706 for inserting feed items into an aggregated feed document.

The feed aggregator has means 703 for calculating a feed item ID value and means 704 for decide whether a feed item from a specific feed channel shall be inserted to the aggregated feed document. This means use the feed item ID value for this decision. The feed aggregator also has means 705 for changing the feed item ID of a feed item.

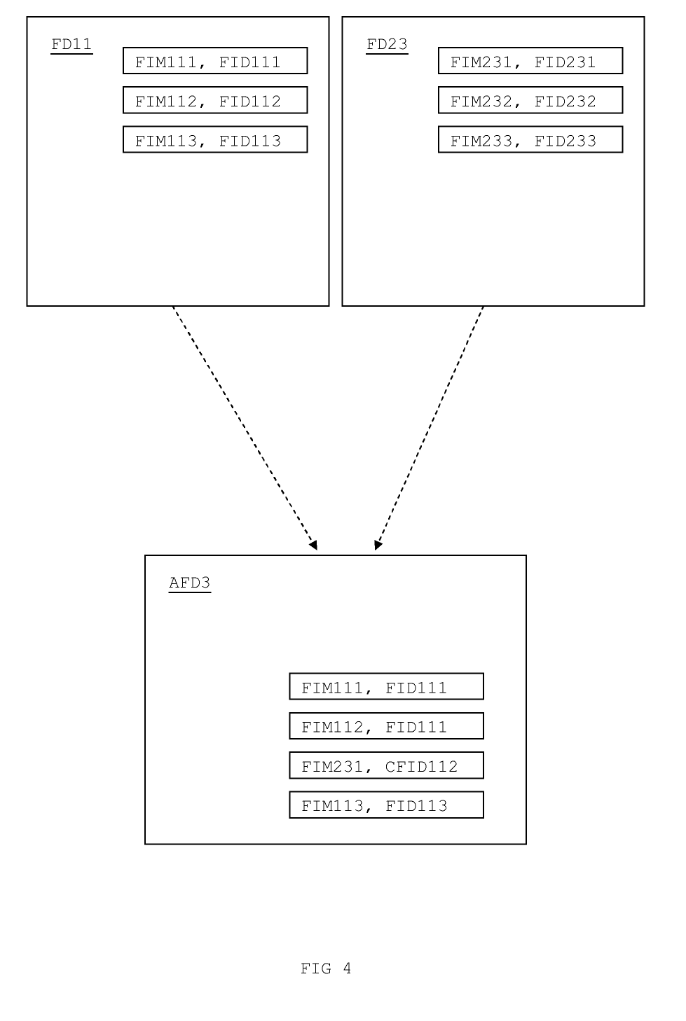

FIG. 4 illustrates how a new aggregated feed document AFD3 is built up. In this example the first feed channel has the same first feed document FD11 as in the example above and in FIG. 3. The second feed channel has updated the second feed document which is now called FD23. The new feed items FIM231 etc have new feed item ID FID231 etc. A new aggregated feed document AFD3 will be built up according to the invention.

The method will be the same as above. The same feed item ID from feed items from the first feed document will give the same result concerning an addition of a feed item from the second feed document FD23. In the aggregated feed document AFD3, the feed items from second feed document FD23 will have the same feed item ID as in the first aggregated feed document AFD2, even though the feed item is changed. This is due to the fact that it is feed item IDs from the first feed document that decides the feed item ID of feed items from the second feed document that is added to the aggregated feed document AFD3.

The result of this method is that the aggregated feed document AFD2 in the first example and the aggregated feed document AFD3 in the second example will look the same concerning the feed item Ids.

If the feed documents in the first and second feed channels are updated the average concentration of feed items for the second feed channel will remain on 20%, independent of which channel that is updated more often than the other.

There can of course be more than two feed channels. Both feed channels from where concentration of feed items will not be controlled and feed channels from where concentration will be controlled. If the feed aggregator inserts feed items from a first feed document and a second feed document and a concentration of 25% from a third feed item document and 25% from a fourth feed document is desired the feed aggregator can be configured to solve this. The feed aggregator can for example calculate feed item ID values from every feed items from the first and the second feed documents that will be randomly between 0 and 1. If the feed item ID value is 0 a feed item from the third feed document will be inserted and if the value is 1 a feed item from the fourth feed document will be added. This will results in 50% of feed items from the first or second feed documents and 25% from the third feed document and 25% from the fourth feed document.

In one scenario a user equipment, e.g. a mobile phone, has a feed reader FD and presents a received feed document according to certain rules in a user feed document. The user equipment will keep track of the read message by storing the feed item ID of the read feed items. The feed reader will suitably put all the unread feed items at the top of the user feed document.

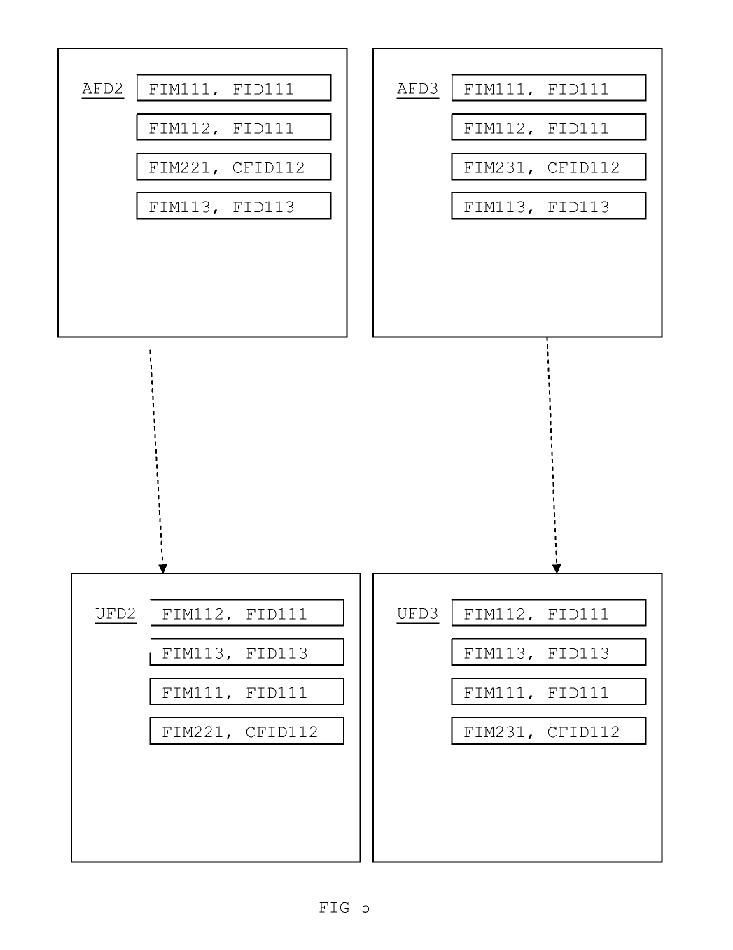

In FIG. 5 the user equipment first receives the aggregated feed document AFD2 and read the first feed item FIM111 and the third feed item FIM221. Next time the user feed document UFD2 is open it will have the first feed item and the third feed items at the bottom of the user feed document because they are read by the user equipment. The unread feed items, the second feed item and the fourth feed item, will be at the top of the user feed document.

If the user equipment receives the new aggregated feed document AFD3 the user feed document UFD3 will have the same order of the feed items as in the user feed document UFD2 above. The third feed item FIM231 in the new feed aggregated feed document AFD3 has the same feed item ID CFID112 as the third feed item FIM221 in the aggregated feed document above and will therefore me marked as read and put at then end of the user feed document UFD3. The user equipment keep track of the read message by storing the feed item ID of the read feed items.

So if the feed document from the second feed channel is updated continuously, the user feed document will look the same, because the updated feed items from the second feed channel will have the same changed feed item ID CFID112. If feed items from the first channel is added, there might be another feed item from the second channel added, in average every fifth time, and those will be marked as unread and put at the top of the user feed document.

The advantage with this method and arrangement is that there is a possibility to control the concentration of feed items from a certain feed channel FC2 in an aggregated feed document. A further advantage is that this concentration will remain in a user feed document as described.

1. A computer-implemented method for inserting feed items into an aggregated feed document, said method comprising:
receiving a first feed item from a first feed document;
inserting the first feed item in an aggregated feed document;
calculating a first feed item ID value of a first feed item ID associated with the first feed item;
using said first feed item ID value to decide when a second feed item from a second feed document is to be inserted into the aggregated feed document and, responsive to deciding that the second feed item is to be inserted, receiving and inserting the second feed item into the aggregated feed document and changing a second feed item ID associated with the second feed item to a changed feed item ID related to characteristics of the first feed item ID, so that the concentration of feed items from the second feed document can be controlled.

2. A method according to claim 1 wherein the first feed item ID value is calculated by taking a hash value of the first feed item ID, and the decision when to insert the second feed item into the aggregated feed document is made in response to said hash value.

3. A method according to claim 1, wherein the first and second feed documents are configured according to the RSS 2.0 standard, and the first and second feed item IDs are globally unique identifiers according to the RSS 2.0 standard.

4. A feed aggregator for creating an aggregated feed document comprising:
means for receiving a first feed item from a first feed document;
means for receiving a second feed item from a second feed document;
means for inserting the first feed item into the aggregated feed document,
means for calculating a first feed item ID value of a first feed item ID associated with the first feed item;
means for deciding when the second feed item is to be inserted into the aggregated feed document in response to said first feed item value, and to selectively insert the second feed item into the aggregated feed document in response to the decision; and
means for changing a second feed item ID associated with the second feed item to a changed feed item ID related to characteristics of the first feed item ID.

5. A feed aggregator according to claim 4, further comprising:
means for calculating the first feed item ID value by taking a hash value of the first feed item ID; and
means for using said hash value to decide when the second feed item is to be inserted.

6. A feed aggregator according to claim 4, wherein the first and second feed documents are configured according to the RSS 2.0 standard, and the first and second feed item IDs are globally unique identifiers according to the RSS 2.0 standard.

7. A feed aggregator for creating an aggregated feed document comprising:
circuitry that is configured to receive a first feed item from a first feed document, to receive a second feed item from a second feed document, to insert the first feed item into the aggregated feed document, to calculate a first feed item ID value of a first feed item ID associated with the first feed item, to selectively insert the second feed item into the aggregated feed document in response to the first feed item value, and to change a second feed item ID associated with the second feed item into a changed feed item ID that has characteristics that are defined in response to the first feed item ID.

8. A feed aggregator according to claim 7, wherein:
the circuitry is further configured to calculate the first feed item ID value by generating a hash value from the first feed item ID, and to use the hash value to decide when to insert the second feed item into the aggregated feed document.

9. A feed aggregator according to claim 7, wherein:
the first and second feed documents are configured according to the RSS 2.0 standard, and the first and second feed item IDs are globally unique identifiers according to the RSS 2.0 standard.

10. A feed aggregator according to claim 7, wherein:
the circuitry is further configured to insert the changed feed item ID into the aggregated feed document in response insertion of the second feed item into the aggregated feed document.
